(19) United States
(12) Patent Application Publication
(10) Pub. No.: US 2019/0332915 A1
(43) Pub. Date: Oct. 31, 2019

(54) METHOD AND SYSTEM FOR INTERACTIVELY ENGAGING A USER OF A VEHICLE

(71) Applicant: WIPRO LIMITED, Bangalore (IN)

(72) Inventors: Gaurav DEVDUTT, Bangalore (IN); Priyanjana Roy, Rajarhat (IN)

(21) Appl. No.: 16/008,063

(22) Filed: Jun. 14, 2018

(30) Foreign Application Priority Data
Apr. 26, 2018 (IN) 201841015785

(51) Int. Cl. G06N 3/00; G06Q 30/06; G10L 15/22

(52) U.S. Cl. CPC G06N 3/006; G10L 2015/223; G10L 15/22; G06Q 30/0625

(57) ABSTRACT

This disclosure relates generally to facilitating product evaluation and use, and more particularly to method and system for interactively engaging a user of a vehicle to facilitate vehicle evaluation and use. In one embodiment, a method for interactively engaging a user of a vehicle is disclosed. The method may include generating a persona of the user using information associated with the user and information in context of the vehicle, obtaining a plurality of real-time parameters associated with the vehicle as the vehicle is being driven by the user, dynamically modelling a two-way conversation model based on the persona of the user and the plurality of real-time parameters associated with the vehicle, and engaging the user in a two-way conversation using the two-way conversation model to provide personalized information about the vehicle in real-time.

### TECHNICAL FIELD

This disclosure relates generally to facilitating product evaluation and use, and more particularly to method and system for interactively engaging a user of a vehicle to facilitate vehicle evaluation and use.

### BACKGROUND

In today's world, before purchasing a product, a buyer may seek information regarding various aspects related to the product. Generally, the buyer is digitally perceptive and traverse several different digital channels to evaluate the product (for example, a vehicle) before visiting a retail store to physically evaluate the product. For example, a vehicle buyer may consult online about a vehicle of interest through different websites. However, the experience of consulting though online sources may not prove satisfying, and the buyer may seek a more personalized experience such as by visiting one or more dealerships for consultation about the product. It has been observed that buyers, who are more technology savvy and digitally adept, seek more rewarding physical experience. In particular, while buying the vehicle, the buyers may expect to receive extensive consultation in form of specific, individually tailored advice or suggestions based on deep product knowledge that may not be obtainable form online sources.

A more satisfying personalized experience may play an important part in closing a deal for car sales. For example, it has been observed that vehicle sales rise about 25% with an improved retail customer experience. Additionally, it has been observed that about 54% of customers choose to buy from a dealership that offers their preferred experience, even though the dealership may not offer the lowest price. Further, it has been observed that on an average a car dealership may be able to generate an additional gross profit of about $100,000 per year by making their customer experience a top priority.

Test-drives form an integral part in a typical process of buying a vehicle, such as a car, and may play a determining role in closing the deal. It is observed that test-drives may increase the deal closing-rate by more than 10% with new guests and almost 15% with appointments. Test-drives may prove even more effective with the sale of used cars. In other words, an immersive and transparent experience afforded by test-drives may play a critical roles in closing a deal.

However, currently the test-drive experience offered to the buyers is quite basic, and is not personalized to the buyer or contextual to location traits. There may be at least 25 different aspects that need to be taken into account for evaluating a new or used vehicle during taking a test drive. However, various aspects may be skipped while evaluating a test drive. Examples of some aspects usually skipped while evaluating a test drive may include: a) operating conditions i.e., steering wheel reaction to high speeds, engine noise at different revolutions per minute (RPM), clutch heaviness, car noise cancellation abilities, body roll, turning radius checks, etc., b) vehicle personalization, c) physical attributes, such as height (affecting the headroom), leg space, front and rear visibility, ingress/egress, etc., d) commute patterns, such different gear ratios which may be recommended for commute at stop and go traffic, higher stance needed for off-roads, vehicle interiors, storage, seat dynamics, safety features (more important for greater travel on highways), or e) previous car ownership. For example, a prospective vehicle buyer may try to benchmark the new car attributes with the experiences of their previous vehicle.

However, these techniques do not provide anything to guide a vehicle buyer to evaluate the vehicle for personal fitment or suitability, or provide knowledge about the vehicle in a transparent manner. Further, the existing techniques fail to provide any performance indicators for auto Original equipment manufacturers (OEM) and dealerships. Further, the existing techniques do not provide anything for better engaging the vehicle buyer (for example, during test drive) through an interactive dialogue so as to enhance the user experience.

### SUMMARY

In one embodiment, a method for interactively engaging a user of a vehicle is disclosed. In one example, the method may include generating a persona of the user using information associated with the user and information in context of the vehicle. The method may further include obtaining a plurality of real-time parameters associated with the vehicle as the vehicle is being driven by the user. The method may further include dynamically modelling a two-way conversation model based on the persona of the user and the plurality of real-time parameters associated with the vehicle. The method may further include engaging the user in a two-way conversation using the two-way conversation model to provide personalized information about the vehicle in real-time.

In one embodiment, a system for interactively engaging a user of a vehicle is disclosed. In one example, the system may include an interactive device including at least one processor and a memory communicatively coupled to the at least one processor. The memory may store processor-executable instructions, which, on execution, may cause the processor to generate a persona of the user using information associated with the user and information in context of the vehicle. The processor-executable instructions, on execution, may further cause the processor to obtain a plurality of real-time parameters associated with the vehicle as the vehicle is being driven by the user. The processor-executable instructions, on execution, may further cause the processor to dynamically model a two-way conversation model based on the persona of the user and the plurality of real-time parameters associated with the vehicle. The processor-executable instructions, on execution, may further cause the processor to engage the user in a two-way conversation using the two-way conversation model to provide personalized information about the vehicle in real-time.

In one embodiment, a non-transitory computer-readable medium storing computer-executable instructions for interactively engaging a user of a vehicle is disclosed. In one example, the stored instructions, when executed by a processor, may cause the processor to perform operations including generating a persona of the user using information associated with the user and information in context of the vehicle. The operations may further include obtaining a plurality of real-time parameters associated with the vehicle as the vehicle is being driven by the user. The operations may further include dynamically modelling a two-way conversation model based on the persona of the user and the plurality of real-time parameters associated with the vehicle. The operations may further include engaging the user in a two-way conversation using the two-way conversation model to provide personalized information about the vehicle in real-time.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. is a block diagram of an exemplary system for interactively engaging a user of a vehicle in accordance with some embodiments of the present disclosure.

FIG. 2 is a functional block diagram of an interactive device in accordance with some embodiments of the present disclosure.

FIG. 3 is a flow diagram of an exemplary process for interactively engaging a user of a vehicle in accordance with some embodiments of the present disclosure.

FIG. 4A and FIG. 4B is a flow diagram of a detailed exemplary process for interactively engaging a user of a vehicle to facilitate vehicle evaluation and use in accordance with some embodiments of the present disclosure.

FIG. 5 is an exemplary two-way conversation between the user and the interactive device using the two-way conversation model in accordance with some embodiments of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Referring now to FIG. 1, an exemplary system 100 for interactively engaging a user of a vehicle is illustrated in accordance with some embodiments of the present disclosure. In particular, the system 100 may include an interactive device 101, a vehicle 102, and a dealer or an original equipment manufacturer (OEM) server 103. As will be appreciated by those skilled in the art, the dealer or the OEM server 103 may be a server of any dealer or any OEM of the vehicle 102 that may provide interactive evaluation or usage of the vehicle 102 to the buyer or the user. Additionally, as will be appreciated by those skilled in art, the vehicle may include at least a number of sensors 104 that may capture various real-time parameters of the vehicle 102.

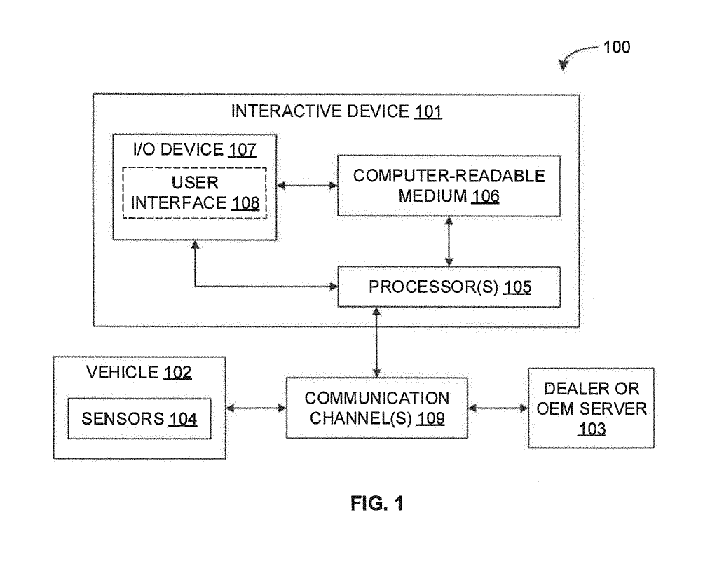

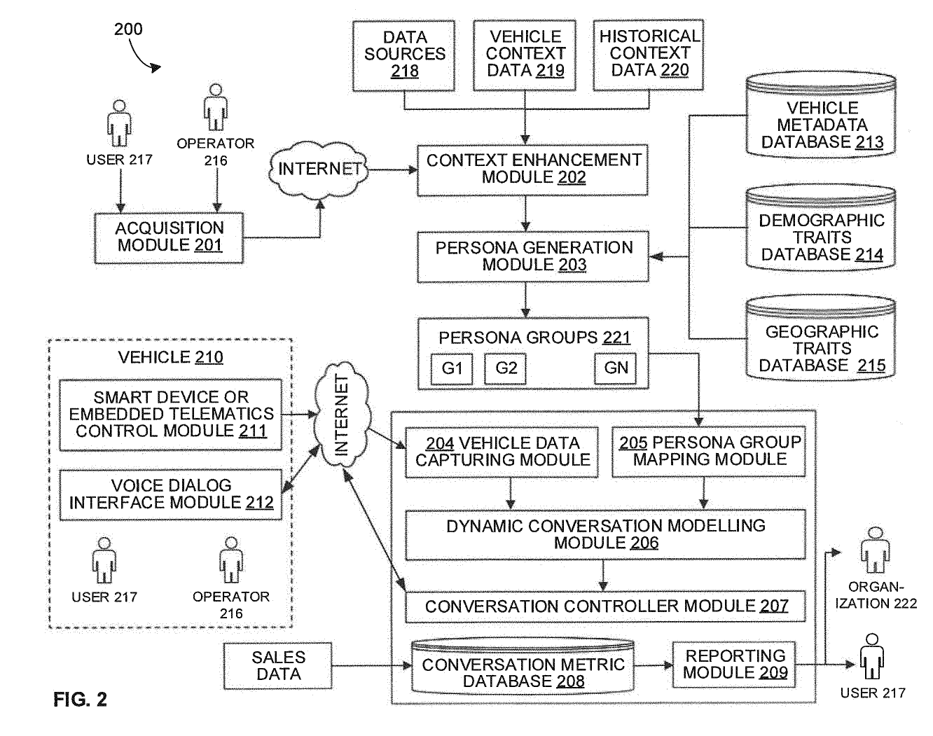

As will be described in greater detail in conjunction with FIGS. 2-5, the interactive device 101 may generate a persona of the user using information associated with the user and information in context of the vehicle 102, obtain a plurality of real-time parameters associated with the vehicle 102 as the vehicle 102 is being driven by the user, dynamically model a two-way conversation model based on the persona of the user and the plurality of real-time parameters associated with the vehicle 102, and engage the user in a two-way conversation using the two-way conversation model to provide personalized information about the vehicle in real-time. The interactive device may further generate, based on the engagement of the user, an evaluation report on an experience of the user with the vehicle, or one or more recommendations for the user, the dealer, or the OEM.

The interactive device 101 may include one or more processors 105, a computer-readable medium (e.g., a memory) 106, and one or more input/output devices 107. The computer-readable medium 106 may store instructions that, when executed by the one or more processors 105 may cause the one or more processors 105 to interactively engage the user of the vehicle in accordance with aspects of the present disclosure. The computer-readable storage medium 106 may also store multiple parameters captured by the sensors 104, information provided by the user or captured from the user, and other data that may be captured, processed, and/or required by the interactive device 101 or the system 100. The one or more processors 105 may perform various data processing functions so as to receive information associated with the user, receive information in context of the vehicle 102, obtain real-time parameters associated with the vehicle 102, dynamically model the two-way conversation model, engage the user in the two-way conversation, provide personalized information, report, or recommendations about the vehicle to the user, dealer, or the OEM. The interactive device 101 may interact with the user via one or more input/output devices 107. For example, the user may provide information to the interactive device 101 or the system 100 via a user interface 108, such as graphic user interface (GUI) or voice based interface, accessible via the input/output devices 107.

Each of the interactive device 101, the vehicle 102, and the dealer or the OEM server 103 may interact among each other over various communication channels 109. For example, in some embodiments, the interactive device 101 may receive the information in context of the vehicle from the dealer or OEM server 103 over a communication channel 109, and may receive real-time parameters from the vehicle 102 over a separate communication channel 109. Alternatively, in some embodiments, the vehicle 102 may receive information in context of the vehicle from the dealer or OEM server 103 over a communication channel 109, while the interactive device 101 may receive real-time parameters as well as the information in context of the vehicle from the vehicle 102 over a separate communication channel 109. The communication channel 109 may be any wired or wireless communication channel based on different communication technologies (e.g., satellite communication technology, television communication technology, mobile communication technologies, WiFi, WiMax, optical fibre, coaxial cable, universal serial bus (USB), high-definition multimedia interface (HDMI), Bluetooth, and so forth).

As will be appreciated, in some embodiments, the interactive device 101 may be located locally with respect to the vehicle 102. For example, in some embodiments, the interactive device 101 may be a separate device in communication with the vehicle 102. For example, the interactive device may be a portable device that may be communicatively connectable with the vehicle 102. Alternatively, in some embodiments, the interactive device 101 may be embedded within the vehicle 102. Further, as will be appreciated, in some embodiments, the interactive device 101 may be located remotely with respect to the vehicle 102. For example, in some embodiments, the interactive device 101 may be located in a remote server of an evaluation service provider. Alternatively, in some embodiments, the interactive device 101 may be embedded within the dealer or OEM server 103.

Further, as will be appreciated, in some embodiments, various components of the interactive device 101 may be physically located together in one device. Alternatively, in some embodiments, the components of the interactive device 101 may be physically distributed across various devices. For example, the processors 105 and the computer readable medium 106 of the interactive device 101 may be physically located together in one device (e.g., the interactive device 101) or may be physically distributed across various devices (e.g., the interactive device 101, the vehicle 102, and/or the dealer or the OEM server 103). Similarly, in some embodiments, some or all of the sensors 104 may be a part of the interactive device 101 even though they may be located in the vehicle 102.

Referring now to FIG. 2, a functional block diagram of the interactive device 200, analogous to the interactive device 101 of FIG. 1, is illustrated in accordance with some embodiments of the present disclosure. The interactive device 200 may include various modules that perform various functions so as to interactively engage with a user 217 of a vehicle 210 in accordance with aspects of the present disclosure. In some embodiments, the interactive device 200 may include an acquisition module 201, a context enhancement module 202, a persona generation module 203, a vehicle data capturing module 204, a persona group mapping module 205, a dynamic conversation modelling module 206, a conversation controller module 207, a conversation metrics database 208, a reporting module 209, a smart device or embedded telematics control module 211, and a voice dialog interface module 212. The interactive device 200 may further include a vehicle metadata database 213, a demographic traits database 214, and a geographic traits database 215 communicatively coupled to the persona generation module 203. As will be appreciated by those skilled in the art, each of the modules or database may reside, in whole or in parts, on any of the interactive device 200, the vehicle 210, or the dealer or the OEM server (not shown). An operator 216, or a user 217 (that is, end user such as vehicle buyer), or an organization user 222 may interact with the interactive device 200 through one or more modules.

The acquisition module 201 may provide an interface to interact with the operator 216 or the user 217 evaluating the vehicle 210. The operator may be a sales executive at the dealership. The user 217 may be a new vehicle buyer evaluating the vehicle 210 or a driver/owner of the new vehicle 210. It should be noted that the term ‘user’ or ‘vehicle buyer’ may be used interchangeably throughout the specification. The acquisition module 201 may receive information from the user 217 either directly or indirectly (for example, through the operator 216 or through other data sources). Such information may be, for example, personalized information of the user, geographic information with respect to a location of the user, or demographic information of the user. The personalized information may include physical attributes of the user 217 (e.g., height, weight, etc.) and aspirations of the user 217. In some embodiments, the operator 216 may interact with the acquisition module 201 to provide answers to personalized questions (hereinafter, referred to as acquisition questionnaire), directed to the user 217, by interacting with the user (vehicle buyer) 217. Alternatively, in some embodiments, the personalized information and the aspirations of the user 217 may be received by the acquisition module 201 via Internet based on user's interaction on various websites (e.g., social media websites, dedicated forums, online vehicle comparison and evaluation websites, etc.).

The acquisition module 201 may capture the answers to the acquisition questionnaire and store them in a digital format. In one embodiment, the acquisition questionnaire may be directed at acquiring, directly or indirectly from the user 217, the physical attributes of the user (weight and height of the user), demographics information of the user (e.g., location, age, gender, ethnicity, occupation, etc.), operating conditions of the vehicle purchased or to be purchased, family size of the user, geographic details of the location of the user (e.g., weather, terrain, etc.), previous vehicle ownership details of the user, commuting patterns of the user, number of typical commutes, nature of commutes, aspirations (make, economy, transmission types, fuel types, goals) of the user, hobbies of the user, likes or dislikes of the user, psychometrics of the user, and so forth. Based on the personalized information and the aspirations of the vehicle buyer 217, the acquisition module 201 may generate a personalized persona for the vehicle buyer 217. The personalized persona for the vehicle buyer 217 generated by the acquisition module 201 may be received by the context enhancement module 202.

The context enhancement module 202 may be communicatively coupled to the acquisition module 201 and configured to receive from the acquisition module 201 the personalized persona generated for the vehicle buyer 217. The context enhancement module 202 may be further configured to enhance the persona generated for the vehicle buyer 217 with additional data to the persona for the vehicle buyer 217. The additional data may include data (e.g., operating context data) from various data sources 218, vehicle context data 219, and historical correlation context data 220 (or simply historical data 220).

The operating context data (data sources) 218 may include third party data sources, such as weather services, accident reports, geography related services, points of interests, census data, vehicle comparison data, vehicle pricing data, vehicle components end of life data, parts metadata and wear and tear information, services and maintenance schedules, and theft and tow statistics. The list may not be considered exhaustive, and the context data 218 may include other types of data as well. The vehicle context data 219 may include data received from a telematics control module or aftermarket on-board diagnostics II (OBDII) based modules. The telematics control module or the aftermarket OBDII based modules may interface vehicle CAN bus. The vehicle context data may further include location data received from Global Positioning System (GPS) sensor, accelerometer data, gyroscope data, and CAN Bus data. The CAN Bus data may further include speed, RPM, throttle position, engine load, Dynamic Traction Control (DTC), distance, Malfunction Indicator Light (MIL) indicator, and so on. The historical data 220 may include data related to previous test drives, data related to previous purchases of the vehicle, data of vehicle wear and tear, statistics on sales, historical weather information, accidents records, etc.

The persona generation module 203 may be communicatively coupled to the context enhancement module 202. The persona generation module 203 may further be configured to receive input from the context enhancement module 202 and to create a personalized persona for the vehicle buyer 217 using the input received. It may be noted that the personalized persona may form basis for creating a plurality of persona groups 221. The plurality of persona groups 221 may be cohorts that may describe needs, aspirations, and preferences of the vehicle buyer 217.

The persona generation module 203 may be communicatively coupled to the vehicle metadata database 213, the demographic traits database 214 and the geography traits database 215. The vehicle metadata database 213 may store vehicle metadata related to typical vehicle specification, such as make, model, year, transmission type, fuel type, body specs, engine specifications, interiors etc. of the vehicle. The vehicle metadata may also include top features, trivia and class leading attributes, comparisons for a vehicle. The demographic traits database may include demographic data related to the vehicle buyer 217. The demographic data may include typical socioeconomic characteristics of the vehicle buyer 217, such as age, sex, education level, income level, marital status, occupation, height, weight, family size, previous vehicle ownership, commute patterns and so on. The geography traits database may include location and geospatial traits, such as commute locations, place of residence, types of travel, temperature, weather patterns, humidity, seasonal aspects etc.

The vehicle data capturing module 204 may be configured to capture real time data related to instantaneous usage of the vehicle as the vehicle is used by the vehicle buyer. In an embodiment, the real time usage data of the vehicle may include angular turn of the steering, degree of acceleration, retardation, instantaneous speed, RPM, engine load, engine parameters from CAN bus of the vehicle, emissions road travelled, weather conditions, speed limits, equipment/accessory/infotainment usage, status of light, seatbelt, ignition, battery, windows, steering, clutch, g-force, and accelerometer inputs. The vehicle data capturing module 204 may be further communicatively coupled to the smart device/embedded telematics control module 221. The vehicle data capturing module 204 may receive from the smart device or embedded telematics control module 221 tracking information of the vehicle and CAN bus data, such as, speed, rpm, engine load, throttle position, accelerometer data, etc.

The persona group mapping module 205 may receive voice based ongoing conversation of the vehicle buyer 217 and decode constructs from the ongoing conversation. Based on the decoded constructs from the ongoing conversation, the persona group mapping module 205 may map the vehicle buyer 217 to map to one of the plurality of persona groups 221. By mapping the vehicle buyer 217 to one of the plurality of persona groups 221, the persona group mapping module 205 may make the succeeding conversation dialog more personal and relevant.

The dynamic conversation modelling module 206 may be communicatively coupled to the vehicle data-capturing module 204 and the persona group-mapping module 205. The dynamic conversation modeler 206 may be configured to receive real time usage data from the vehicle data-capturing module 204. The dynamic conversation modeler 206 may be further configured to receive the persona group 221 from the persona group mapping module 206. Using the real time usage data and persona group 221, the dynamic conversation modeler 206 may be further configured to generate a personalized evaluation criteria conversational model. In one embodiment, the evaluation criteria conversation model may be a series of utterances and dialog, which may be used to converse with the vehicle buyer 217 while the vehicle is used by the vehicle buyer 217 for evaluating the vehicle. Based on the persona group 221, the evaluation criteria conversation model may guide the vehicle buyer 217 to evaluate the vehicle based on the fitment or suitability with respect to the need of the vehicle buyer determined earlier. Further, a speaking bot may be used to converse with the vehicle buyer in real time.

The conversation controller module 207 may be configured to control the conversation flow between the vehicle buyer 217 and the voice dialog interface 212. The conversation controller module 207 may control the conversation flow based on level of engagement with the vehicle buyer 217, response received from the vehicle buyer 217 and prioritization set by the evaluation criteria conversation model. It may be noted that during the course of the conversation, conversation statistics may be generated which may take into consideration length of the conversation, engagement level, feedback received form the vehicle buyer 217, operating context such as time of day, weather, operator, location, and so on. This information may further be correlated with historical closing rates to determine marketing metrics. These marketing metrics may help Original Equivalent Manufacturers (OEM) and dealerships to understand the vehicle buyer and the various factors influencing a sale of a vehicle in a better and effective manner. Further, additional metrics may be generated to provide the vehicle buyer 217 with detailed information on the trip and fitment evaluation checklist. The conversation controller module 207 may further model the inputs from the dynamic conversation modeler 206 into a personalized model tailored towards the vehicle buyer 217 and to control the conversation flow.

The conversation metrics database 208 may be configured to define tailored metrics for the OEM, dealership, and vehicle buyer based on the conversation. The conversation metrics database 208 may generate conversation metrics based on the guided conversation with the vehicle buyer and the historical sales data. The output of the conversation metrics database 208 i.e. the conversation metrics may be sent to the reporting module 209.

The reporting module 209 may be communicatively coupled to the conversation metrics database 208, and may receive the conversation metrics from the conversation metrics database 208. Using the conversation metrics, the reporting module 209 may generate correlation reports to form market analytics reports which are relevant to OEMs and dealerships. The reporting module 209 may also generate a fitment report to vehicle buyer which details transparently the fitment information of the vehicle based on the personal group and how the vehicle buyer has driven during the evaluation.

The vehicle 210 may include a smart device/embedded telematics control module 211 and a voice dialog interface 212. The smart device/embedded telematics control module 211 may be in form of embedded systems on board a vehicle or in form of aftermarket smart devices. In one embodiment, the smart device/embedded telematics control module 211 may plug in to On-board diagnostics II port (OBD II port). The device/embedded telematics control module 211 may receive tracking information of the vehicle along with CAN bus data such as speed, RPM, engine load, throttle position, and accelerometer data. The device/embedded telematics control module 211 may additionally transmit the data to the cloud via a cellular connection (SIM card), or a Bluetooth tethered option.

It should be noted that the interactive device 101 may be implemented in programmable hardware devices such as programmable gate arrays, programmable array logic, programmable logic devices, and so forth. Alternatively, the interactive device 101 may be implemented in software for execution by various types of processors. An identified engine of executable code may, for instance, include one or more physical or logical blocks of computer instructions which may, for instance, be organized as an object, procedure, function, module, or other construct. Nevertheless, the executables of an identified engine need not be physically located together, but may include disparate instructions stored in different locations which, when joined logically together, include the engine and achieve the stated purpose of the engine. Indeed, an engine of executable code could be a single instruction, or many instructions, and may even be distributed over several different code segments, among different applications, and across several memory devices,

As will be appreciated by one skilled in the art, a variety of processes may be employed for interactively engaging a user of a vehicle. For example, the exemplary system 100 and the associated interactive device 101 may interactively engage with the user of the vehicle by the processes discussed herein. In particular, as will be appreciated by those of ordinary skill in the art, control logic and/or automated routines for performing the techniques and steps described herein may be implemented by the system 100 and the associated interactive device 101, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

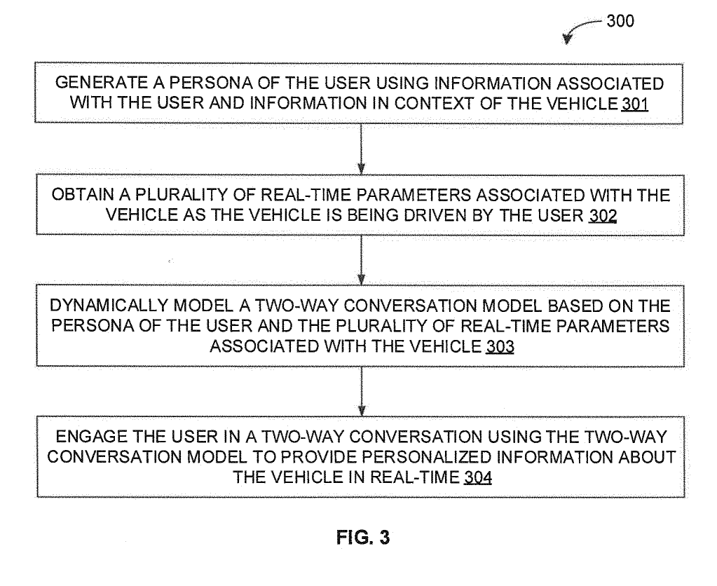

For example, referring now to FIG. 3, exemplary control logic 300 for interactively engaging a user of a vehicle via a system, such as system 100, is depicted via a flowchart in accordance with some embodiments of the present disclosure. As illustrated in the flowchart, the control logic 300 may include the steps of generating a persona of the user using information associated with the user and information in context of the vehicle at step 301, obtaining a plurality of real-time parameters associated with the vehicle as the vehicle is being driven by the user at step 302, dynamically modelling a two-way conversation model based on the persona of the user and the plurality of real-time parameters associated with the vehicle at step 302, and engaging the user in a two-way conversation using the two-way conversation model to provide personalized information about the vehicle in real-time at step 304. In some embodiments, the control logic 300 may further include the step of generating, based on the engagement of the user, at least one of an evaluation report on an experience of the user with the vehicle, or one or more recommendations.

In some embodiments, the information associated with the user may include at least one of personal information of the user, geographic information with respect to a location of the user, or demographic information of the user. For example, the information associated with the user may include, but may not be limited to, a weight of the user, a height of the user, a gender of the user, an ethnicity of the user, an occupation of the user, a location of the user, geographic information of the location, a terrain of the location, a weather at the location, an operational use of the vehicle, a family size of the user, a vehicle ownership history of the user, commute patterns of the user, personal interests of the user, an aspiration of the user with respect to a new vehicle, one or more hobbies of the user, or a psychometric data of the user.

Additionally, in some embodiments, information in context of the vehicle may include at least one of information with respect to the vehicle, or historical context with respect to the use of the vehicle. For example, information with respect to the vehicle may include static features of the vehicle including, but not limited to, seating capacity, engine volume, generated thrust, safety features, entertainment features, comfort features, and so forth. Further, for example, historical context with respect to the use of the vehicle may include, but may not be limited to, information generally sought by other users having similar persona or similar demographics, their eventual buys, features that impressed them most, and so forth.

Further, in some embodiments, the real time parameters associated with the vehicle may include at least one of operational parameters of the vehicle, environmental parameters with respect to the vehicle, or usage parameters with respect to one or more features of the vehicle. For example, the real time parameters associated with the vehicle may include, but may not be limited to, an angular turn of the steering, a degree of acceleration, a degree of retardation, an instantaneous speed, a revolutions per minute (rpm), an engine load, an emission value, a road condition, a weather condition, a speed limit, a usage of vehicle equipment, a fuel consumption, an engine coolant level, an odometer reading, a vehicle diagnostics code, a vehicle lighting usage, a seatbelt usage, a battery usage, a window usage, a steering setting, a clutch usage, a degree of breaking, a usage of accessories, or data from controller area network (CAN) bus.

In some embodiments, generating the persona of the user at step 301 may include enriching the information associated with the user based on the information in context of the vehicle. Additionally, in some embodiments, dynamically modelling the two-way conversation model at step 303 may include generating a plurality of personalized conversation dialog flow outlines for performing the two-way conversation, and generating a plurality of decision flow outlines for navigating the two-way conversation.

In some embodiments, engaging the user in the two-way conversation may include generating a custom response to a query from the user. Additionally, in some embodiments, engaging the user in the two-way>conversation may include generating a personalized conversational dialog for the user, and receiving a feedback from the user to the personalized conversational dialog. In such embodiments, the personalized conversational dialog may include, but may not be limited to, a prodding the user to perform certain action with respect to the vehicle, prodding the user to explore certain feature of the vehicle, or providing information on an important feature of the vehicle. Further, in such embodiments, the control logic 300 may further include the step of iteratively refining the personalized conversational dialog based on the feedback.

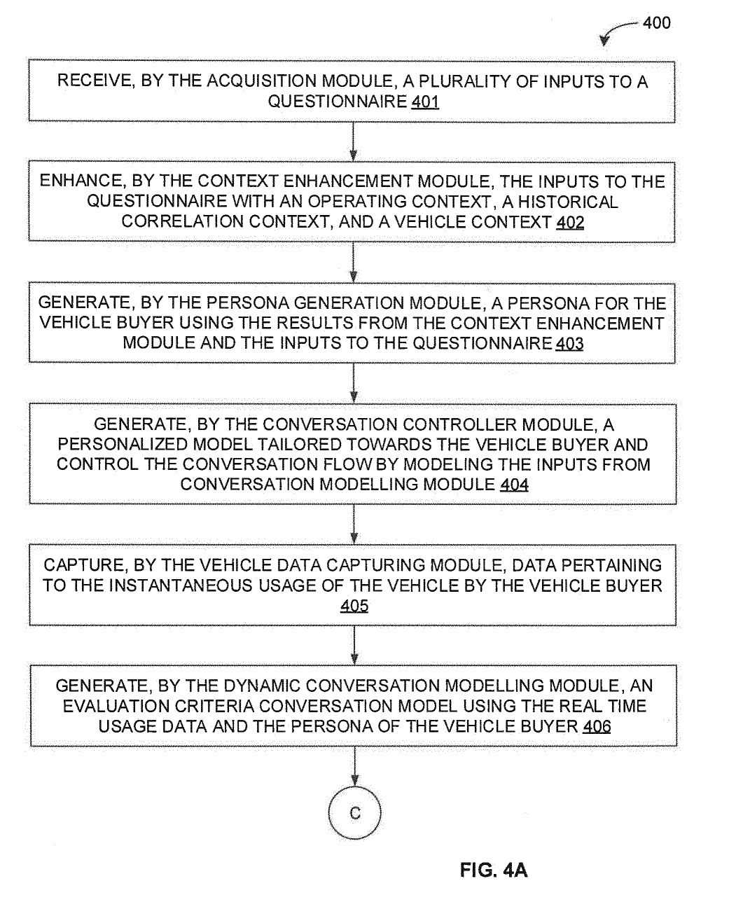

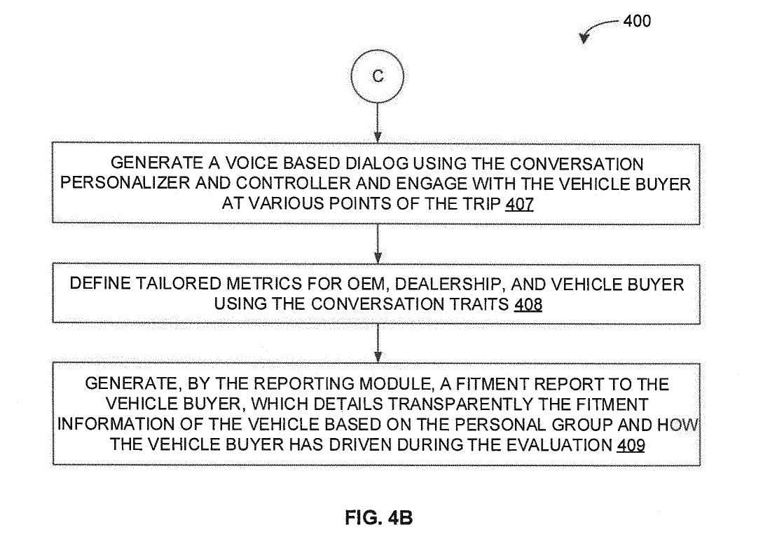

Referring now to FIG. 4A and FIG. 4B, exemplary control logic 400 for interactively engaging a user of a vehicle to facilitate vehicle evaluation and use is depicted in greater detail via a flowchart, in accordance with some embodiments of the present disclosure. As illustrated in the flowchart, at step 401, a plurality of questions (questionnaire) may be received by an acquisition module 201. In one embodiment, an operator 216 may use the acquisition module 201 for eliciting answers to the questionnaire directed to a vehicle buyer 217. By way of an example, the questionnaire may be intended to define aspirations, trait or persona of the vehicle buyer 217. In other words, the questionnaire may be intended to receive from the vehicle buyer 217 attributes for evaluating the vehicle. The personalized questions may further be directed at acquiring physical attributes of the vehicle buyer 217, and demographic information. By way of an example, the physical attributes of the vehicle buyer 217 may include weight and height of the vehicle buyer 217. The demographic information may include operating conditions of the vehicle 210, family size of the vehicle buyer 217, weather conditions, previous ownership of the vehicle 210, commute patterns, number of typical commutes, nature of commutes, and aspirations of the vehicle buyer 217 associated with the new vehicle. The aspirations of the vehicle buyer 217 associated with the vehicle 210 may include make, economy, transmission types, fuel types of the vehicle, and goals, occupation, hobbies, likes and dislikes, and psychometrics of the vehicle buyer 217.

At step 402, the answers received from the vehicle buyer 217 as elicited by the operator 216 to the questionnaire may be enhanced by a context enhancement module 202. In one embodiment, the answers to the personalized questions may be enhanced by the context enhancement module 202 using operating context data 218, vehicle context data 219, and historical correlation context data 220. It should be noted that, the operating context data 218, vehicle context data 219, and historical correlation context data 220 are already described in detail above. The attributes for evaluating the vehicle received though the questionnaire may be further supplemented with past context and present context, peer traits and traits of the cohorts, so that a definitive persona of the vehicle buyer 217 may be created.

At step 403, persona of the vehicle buyer 217 may be generated by a persona generation module 203. The persona of the vehicle buyer 217 may be generated using inputs from the context enhancement module 202 and the answers to the personalized questions. Further, at step 403, the attributes for evaluating the vehicle received from the vehicle buyer 217 through the questionnaire may be combined with context of weather, traffic, road, speed limits, safety information, accident information, sales data, vehicle data, general demographic traits, geographic traits, purchase patterns, peer commute patterns, vehicle degradation traits to form the persona for the vehicle buyer 217.

At step 404, a personalized model tailored towards the vehicle buyer 217 and to control a conversation flow by modeling inputs from a conversation modeler 206 may be generated by a conversation controller module 207. Further, at step 404, the persona of the vehicle buyer 217 may be classified in a group of similar personas. In one embodiment, the persona of the vehicle buyer 217 may be classified using a combination of balanced scorecard approach and taxonomy to each attribute for evaluating the vehicle. Additionally, each group of personas may be mapped to a personalized conversation dialog flow relevant to that group of personas so as to form a basis of conversation with the vehicle buyer 217. It may be noted that a speaking bot may be used to converse with the vehicle buyer 217 in real time. Further, at step 404, steps may be outlined by the personalized conversation dialog flow that the voice bot may take in initiating, accepting and routing the conversation with the vehicle buyer. Moreover, a decision flow may be outlined by the voice bot on navigating the conversation further. It may be further noted that the decision flow may be personalized for the group of personas the vehicle buyer 217 is mapped to.

At step 405, real-time usage data pertaining to the instantaneous usage of the vehicle by the vehicle buyer may be captured by the vehicle data capturing module 204. As mentioned earlier, the real time usage data may include angular turn of the steering, degree of acceleration, retardation, instantaneous speed, RPM, engine load, engine parameters from CAN bus of the vehicle, emissions, road travelled, weather conditions, speed limits, equipment and accessory (such as infotainment system) usage, status of light, seatbelt, ignition, battery, windows, steering, clutch, G-force and accelerometer inputs. The real time usage data may later be used to take immediate decisions on re-routing the conversational flow, educating the vehicle buyer 217 of any interesting usage traits that are currently analyzed during the evaluation of the vehicle, and generating a final report of the evaluation of the vehicle configuration. This is further explained step 406.

At step 406, an evaluation criteria conversation model may be generated by a dynamic conversation modeler 206. The evaluation criteria conversation model may be generated using the real time usage data and the persona of the vehicle buyer 217. The evaluation criteria conversation model may later be used for generating a voice based dialog. Further, at step 406, the real time usage data (generated at step 405) may be used to determine rerouting decisions on the conversational flow, to educate the users of any interesting traits observed during the drive. Additionally, the real time usage data may be used to reformulate the conversational flow to make it more personalized and contextual based on the data received from the vehicle and the vehicle user persona group.

At step 407, a voice based dialog may be generated using a conversation personalizer and controller and to engage the vehicle buyer at various points of time during the trip. The voice base dialog and utterances may be generated by a voice dialog interface 212 using inputs from the dynamic conversation modeler 206. Using the voice base dialog and the utterances, the vehicle buyer 217 may be engaged at various points of time during the trip. Further, at step 407, voice based conversation may be received back by the voice dialog interface 212 from the vehicle buyer 217. Additionally, inputs may be taken from the conversation flow defined earlier so as to converse back, thereby making the conversation un-bot like, personal and engaging. This may help the vehicle buyer 217 to arrive at the right fitment information about the vehicle.

At step 408, tailored metrics for Original Equipment Manufacturer (OEM), dealership and vehicle buyer 217 may be defined based on the conversation. It may be noted that the tailored metrics for OEM, dealership, and vehicle buyer 217 may be defined using the conversation metrics generator using the conversation. In an embodiment, the tailored metrics for the OEM, dealership and the vehicle buyer 217 may include duration of engagement, correlation of engagement, persona type, operating context, demographics traits, time of day, and mood of individual with vehicles sales. Additionally, the tailored metrics may represent feedback received from the vehicle buyer 217 so as to refine the value proposition forward.

At step 409, a fitment report may be generated for the vehicle buyer 217. The fitment report may transparently provide details about the fitment information of the vehicle based on the personal group and how the vehicle buyer has driven during the evaluation.

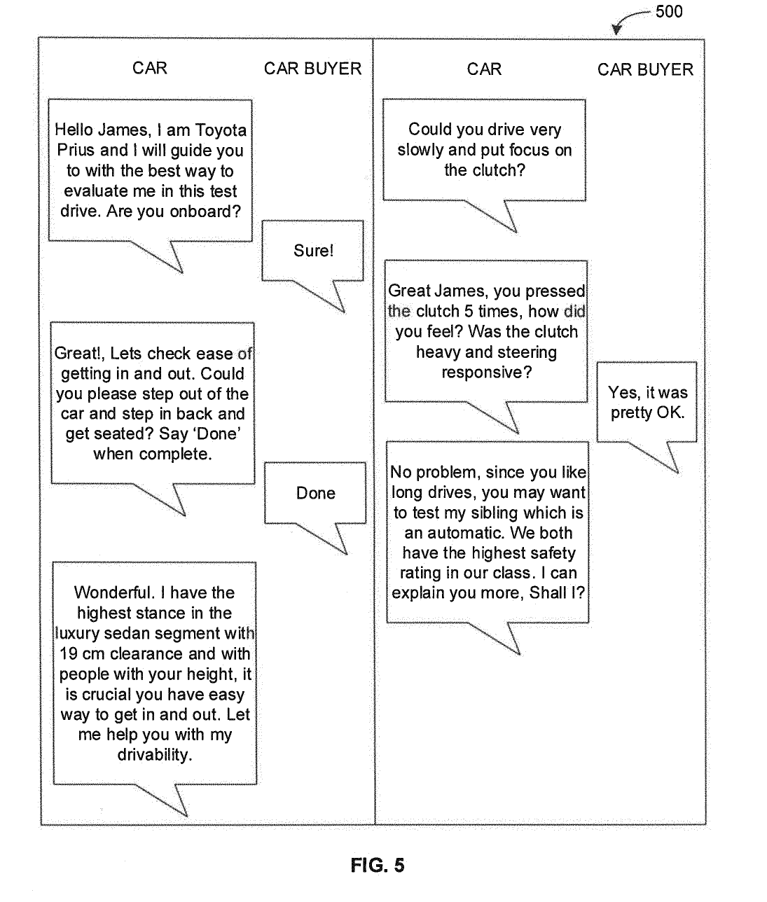

Referring now to FIG. 5, exemplary two-way conversation 500 between the user and the interactive device using the two-way conversation model is illustrated, in accordance with some embodiments of the present disclosure. As will be appreciated, the two-way conversation 500 illustrate a very small scenario, where the interactive device may notify the user and help the vehicle buyer with interesting information about the vehicle, the right way to evaluate the vehicle, and guides the vehicle buyer with personalized fitment criteria based on details relevant to vehicle buyer.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

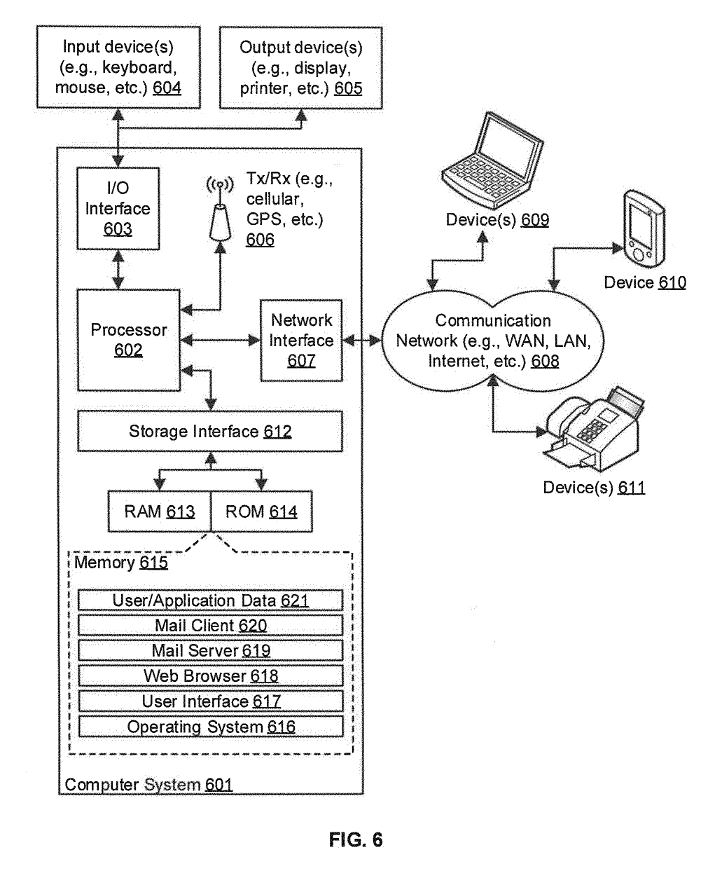

The disclosed methods and systems may be implemented on a conventional or a general-purpose computer system, such as a personal computer (PC) or server computer. Referring now to FIG. 6, a block diagram of an exemplary computer system 601 for implementing embodiments consistent with the present disclosure is illustrated. Variations of computer system 601 may be used for implementing system 100 and interactive device 200 for interactively engaging a user of a vehicle. Computer system 601 may include a central processing unit (“CPU” or “processor”) 602. Processor 602 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dangle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM4550IUB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK®, etc.), laptop computers, notebooks, gaming consoles (MICROSOFT® XBOX®, NINTENDO® DS®, SONY® PLAYSTATION®, etc.), or the like. In some embodiments, the computer system 601 may itself embody one or more of these devices.

In some embodiments, the processor 602 may be disposed in communication with one or more memory devices (e.g., RAM 613, ROM 614, etc.), collectively referred to as memory 615, via a storage interface 612. The storage interface 612 may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 615 may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 601 may implement a web browser 618 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 601 may implement a mail server 619 stored program component. The mail server may be an Internet mail server such as MICROSOFT® EXCHANGE®, or the like. The mail server may utilize facilities such as ASP, ActiveX, ANSI C++/C#, MICROSOFT .NET® CGI scripts, JAVA®, JAVASCRIPT®, PERL®, PHP®, PYTHON®, WebObjects, etc. The mail server may utilize communication protocols such as Internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, computer system 601 may store user/application data 621, such as the data, variables, records, etc. (e.g., questionnaire, user inputs, information associated with the user, information associated with the vehicle, real-time parameters, the two-way conversation model, actual two-way conversation, feedbacks, reports, and so forth) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®. ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above may provide for interactively engaging a user of a vehicle so as to facilitate vehicle evaluation and use. In particular, the techniques provide for a personalized or enhanced information to the user so as to provide assistance with respect to the recently purchased vehicle during normal drive, or for facilitating evaluation of the vehicle during test drive. Thus, unlike the conventional mechanisms, a personalized conversational model may be generated based on a set of personalized answers from the vehicle buyer, contextual data from varied data sources, and real-time usage data from the vehicle in order to engage the vehicle buyer using two-way conversation, and to guide the vehicle buyer in vehicle evaluation. The above described techniques may transparently provide factual personalized information about the vehicle fitment by generating a fitment evaluation report of the vehicle for the user.

Additionally, the techniques described above may conversationally educate the user about important features of the vehicle. Further, the techniques may further provide targeted recommendation that may facilitate in sale of accessories, upselling and cross selling of the vehicle based on engagement, test drive usage pattern, and persona of the user. Moreover, the techniques may provide for generating a report for dealership and automakers on the conversational metrics and market analytics based on correlation of buying behavior with the test drive quality and engagement metrics.

The specification has described system and method for interactively engaging a user of a vehicle. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of interactively engaging a user of a vehicle, the method comprising:
generating, by an interactive device, a persona of the user using information associated with the user and information in context of the vehicle;
obtaining, by the interactive device, a plurality of real-time parameters associated with the vehicle as the vehicle is being driven by the user;
dynamically modelling, by the interactive device, a two-way conversation model based on the persona of the user and the plurality of real-time parameters associated with the vehicle; and
engaging, by the interactive device, the user in a two-way conversation using the two-way conversation model to provide personalized information about the vehicle in real-time.

2. The method of claim 1, wherein the information associated with the user comprises at least one of personal information of the user, geographic information with respect to a location of the user, or demographic information of the user.

3. The method of claim 1, wherein information in context of the vehicle comprises at least one of information with respect to the vehicle, or historical context with respect to the use of the vehicle.

4. The method of claim 1, wherein generating the persona of the user comprises enriching the information associated with the user based on the information in context of the vehicle.

5. The method of claim 1, wherein the real time parameters associated with the vehicle comprise at least one of operational parameters of the vehicle, environmental parameters with respect to the vehicle, or usage parameters with respect to one or more features of the vehicle.

6. The method of claim 1, wherein dynamically modelling the two-way conversation model comprises generating a plurality of personalized conversation dialog flow outlines for performing the two-way conversation, and generating a plurality of decision flow outlines for navigating the two-way conversation.

7. The method of claim 1, wherein engaging the user in the two-way conversation comprises generating a custom response to a query from the user.

8. The method of claim 1, wherein engaging the user in the two-way conversation comprises:
generating a personalized conversational dialog for the user; and
receiving a feedback from the user to the personalized conversational dialog,

9. The method of claim 8, wherein the personalized conversational dialog comprises at least one of a prodding the user to perform certain action with respect to the vehicle, prodding the user to explore certain feature of the vehicle, or providing information on an important feature of the vehicle.

10. The method of claim 8, further comprising iteratively refining the personalized conversational dialog based on the feedback.

11. The method of claim 1, further comprising generating, based on the engagement of the user, at least one of:
an evaluation report on an experience of the user with the vehicle, or
one or more recommendations.

12. A system for interactively engaging a user of a vehicle, the system comprising:
an interactive device comprising at least one processor and a computer-readable medium storing instructions that, when executed by the at least one processor, cause the at least one processor to perform operations comprising:
generating a persona of the user using information associated with the user and information in context of the vehicle;
obtaining a plurality of real-time parameters associated with the vehicle as the vehicle is being driven by the user;
dynamically modelling a two-way conversation model based on the persona of the user and the plurality of real-time parameters associated with the vehicle; and
engaging the user in a two-way conversation using the two-way conversation model to provide personalized information about the vehicle in real-time.

13. The system of claim 12, wherein generating the persona of the user comprises enriching the information associated with the user based on the information in context of the vehicle.

14. The system of claim 12, wherein dynamically modelling the two-way conversation model comprises generating a plurality of personalized conversation dialog flow outlines for performing the two-way conversation, and generating a plurality of decision flow outlines for navigating the two-way conversation.

15. The system of claim 12, wherein engaging the user in the two-way conversation comprises generating a custom response to a query from the user.

16. The system of claim 12, wherein engaging the user in the two-way conversation comprises:
generating a personalized conversational dialog for the user; and
receiving a feedback from the user to the personalized conversational dialog.

17. The system of claim 16, wherein the personalized conversational dialog comprises at least one of a prodding the user to perform certain action with respect to the vehicle, prodding the user to explore certain feature of the vehicle, or providing information on an important feature of the vehicle.

18. The system of claim 16, wherein the operations further comprise iteratively refining the personalized conversational dialog based on the feedback.

19. The system of claim 12, wherein the operations further comprise generating, based on the engagement of the user, at least one of:
an evaluation report on an experience of the user with the vehicle, or
one or more recommendations.

20. A non-transitory computer-readable medium storing computer-executable instructions for:
generating a persona of the user using information associated with the user and information in context of the vehicle;
obtaining a plurality of real-time parameters associated with the vehicle as the vehicle is being driven by the user;
dynamically modelling a two-way conversation model based on the persona of the user and the plurality of real-time parameters associated with the vehicle: and
engaging the user in a two-way conversation using the two-way conversation model to provide personalized information about the vehicle in real-time.
